(19) United States
(12) Patent Application Publication
(10) Pub. No.: US 2014/0298059 A1
(43) Pub. Date: Oct. 2, 2014

(54) ELECTRONIC APPARATUS AND ASSOCIATED POWER MANAGEMENT METHOD

(71) Applicant: Wistron Corporation, New Taipei City (TW)

(72) Inventors: Chia-Wei Kao, New Taipei City (TW); Chao-Hsuan Lin, New Taipei City (TW); Chih-Hung Chien, New Taipei City (TW)

(73) Assignee: Wistron Corporation, New Taipei City (TW)

(21) Appl. No.: 14/074,749

(22) Filed: Nov. 8, 2013

(30) Foreign Application Priority Data
Mar. 29, 2013 (TW) 102111516

(51) Int. Cl. G06F 1/32

(52) U.S. Cl. CPC G06F 1/3268
USPC 713/323

(57) ABSTRACT

An electronic apparatus is provided. The electronic apparatus includes a dynamic random access memory (DRAM), a power integrated circuit (IC), and a central processing unit (CPU). When a standby mode of the electronic apparatus is set to a fast reboot mode, the CPU stops providing a clock signal to the DRAM and controls the power IC to continuously supplying power to the DRAM, so that the DRAM enters a self-refresh mode.

This application claims the benefit of Taiwan application Serial No. 102111516, filed Mar. 29, 2013, the subject matter of which is incorporated herein by reference.

### BACKGROUND OF THE INVENTION

1. Field of the Invention

The invention relates in general to an apparatus, and more particularly to an electronic apparatus and an associated power management method.

2. Description of the Related Art

An Energy-using Products (EuP) standard of the European Union (EU) chiefly is for establishing an ecologic design architecture for increasing energy efficiency of EuPs, and for ensuring free circulation of products within the EU market. In the EuP standard, it is specified that manufacturers are required to, by adopting a concept of lifecycle, incorporate an ecologic design into researches and developments of products. Main target products in the standard include boilers, furnaces, computers and associated information products, consumer electronic products, chargers and power supplies, illumination lightings, air conditioning and ventilation equipments, pumps, refrigerating equipments and washing equipments. However, as power consumption regulations that different countries define for electronic products are different, there is a need for a solution for electronic products to meet power consumption regulations of different countries without increasing costs.

### SUMMARY OF THE INVENTION

The invention is directed to an electronic apparatus and an associated power management method.

According to the present invention, an electronic apparatus is provided. The electronic apparatus includes a dynamic random access memory (DRAM), a power integrated circuit (IC), and a central processing unit (CPU). When a standby mode of the electronic apparatus is set to a fast reboot mode, the CPU stops providing a clock signal to the DRAM and controls the power IC to continuously supplying power to the DRAM, so that the DRAM enters a self-refresh mode.

According to the present invention, a power management method for an electronic apparatus is provided. The power management method includes: when a standby mode of the electronic product is set to a fast reboot mode, stopping providing a clock signal to a DRAM and continuously supplying power to the DRAM; and the DRAM entering a self-refresh mode.

According to the present invention, a power management method for an electronic apparatus is further provided. The power management method includes: providing a user interface for setting a standby mode; when the standby mode of the electronic product is set to a fast reboot mode, stopping providing a clock signal to a DRAM and continuously supplying power to the DRAM, so that the DRAM enters a self-refresh mode; and when the standby mode is set to a power-saving mode, stopping providing the clock signal to the DRAM and stopping supplying power to the DRAM.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of an electronic apparatus according to an embodiment of the present invention; and

FIG. 2 is a flowchart of a power management method for an electronic apparatus according to an embodiment of the present invention.

### DETAILED DESCRIPTION OF THE INVENTION

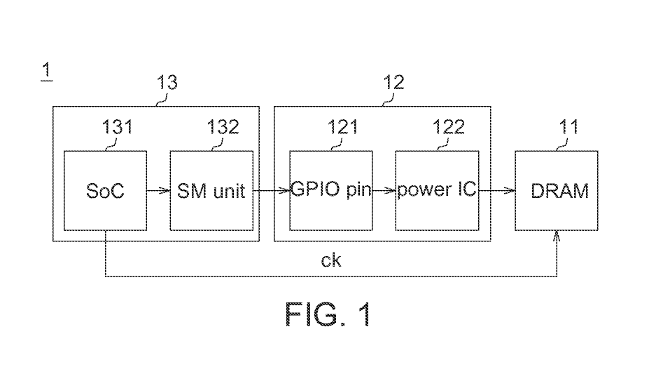

FIG. 1 shows a block diagram of an electronic apparatus according to an embodiment of the present invention. An electronic device 1, e.g., a set-top box, includes a dynamic random access memory (DRAM) 11, a power integrated circuit (IC) 12, and a central processing unit (CPU) 13. The power IC is coupled to the DRAM 11 and the CPU 13, and includes a power supply circuit 122 and a general purpose input/output (GPIO) pin 121. The CPU 13 includes a system-on-chip (SoC) 131 and a system management (SM) unit 132.

After the electronic apparatus 1 is booted, the CPU 13 provides a user interface. Via the user interface, a user may set a standby mode of the electronic apparatus 1 to a fast reboot mode or a power-saving mode. In one embodiment, after selecting the fast reboot mode or the power-saving mode, the user may press a power key of the electronic apparatus 1 so that the electronic apparatus 1 enters the selected standby mode. A first wake-up time is required for returning to the user interface from the fast reboot mode, and a second wake-up time is required for returning to the user interface from the power-saving mode. The first wake-up time is shorter than the second wake-up time. For example, the first wake-up time is 3 seconds, and the second wake-up time is 10 seconds.

The CPU 13 determines whether the standby mode is set to the fast reboot mode. When the standby mode of the electronic apparatus 1 is set to the fast reboot mode, the SoC 131 stops providing a signal clock CK to the DRAM 11, and the SM unit 132 controls the power IC 12 via the GPIO pin 121 to continuously supplying the power to the DRAM 11, so that the DRAM 11 enters a self-refresh mode.

The self-refresh mode is a mode in which a built-in and independent charging circuit in the DRAM self-charges at a predetermined time interval. After entering the fast reboot mode, a current consumption of the DRAM 11 is approximately 15 mA to 30 mA, and power consumption is approximately 0.54 W. Since data in the DRAM 11 is continually stored in intact during the self-refresh mode, and the DRAM 11 is self-charged at a predetermined time interval, in the fast reboot mode, the time required for returning to the user interface from the fast reboot mode is shorter than 3 seconds. When the standby mode is set to the fast reboot mode, the power consumption is approximately 0.54 W, and so the power consumption of the self-refresh mode meets the Energy Star standard.

In contrast, when the standby mode is set to the power-saving mode, the SoC 131 stops providing the clock signal CK to the DRAM 11, and the SM unit 132, via the GPIO pin 121, controls the power IC 12 to stop supplying the power to the DRAM 11. As the power IC 12 no longer powers the DRAM 11, a power-saving effect is achieved. When the standby mode is set to the power-saving mode, the power consumption of the electronic apparatus 1 is smaller than 0.5 W. For example, after entering the power-saving mode, the power consumption is 0.45 W. When the standby mode is set to the power-saving mode, with the power consumption of 0.45 W, the power consumption of the power-saving mode meets the EuP standard.

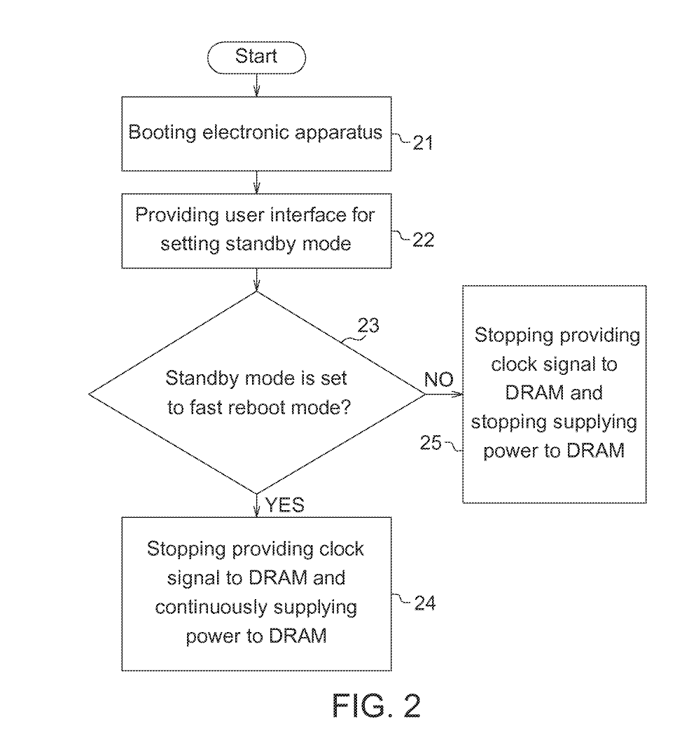

FIG. 2 shows a flowchart of a power management method for an electronic apparatus according to an embodiment of the present invention. Referring to FIGS. 1 and 2, the power management method for the electronic apparatus 1 includes the following steps. In step 21, the electronic apparatus 1 is booted. In step 22, the CPU 13 provides a user interface for setting a standby mode. In step 23, the CPU 13 determines whether the standby mode is set to a fast reboot mode. Step 24 is performed when the standby mode is set to the fast reboot mode. In step 24, the SoC 131 stops providing a clock signal CK to the DRAM 11, and the SM unit 132, via the GPIO pin 121, controls the power IC 12 to continuously supplying the power to the DRAM 11, so that the DRAM 11 enters a self-refresh mode.

Conversely, when the standby mode is not set to the fast reboot mode, it means that the standby mode is set to a power-saving mode. When the standby mode is set to the power-saving mode, step 25 is performed. In step 25, the SoC 131 stops providing the clock signal CK to the DRAM 11, and the SM unit 132, via the GPIO pin 121, controls the power IC 12 to stop supplying the power to the DRAM 11.

In the foregoing embodiments disclosing the electronic apparatus and the power management method for the electronic device, two different standby modes are provided. For meeting the Energy Start standard, the standby mode can be set to a fast reboot mode, such that the electronic apparatus is capable of quickly returning to the user interface from the fast reboot mode. For meeting the EuP standard, the standby mode may be set to a power-saving mode. Without additional electronic elements, the electronic apparatus and the associated power management method offer users with more options for significantly enhancing usage conveniences as well as product competitiveness.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic apparatus, comprising:
a dynamic random access memory (DRAM);
a power integrated circuit (IC); and
a central processing unit (CPU), configured to stop providing a clock signal to the DRAM and control the power IC to continuously supply power to the DRAM when a standby mode of the electronic apparatus is set to a fast reboot mode, so that the DRAM enters a self-refresh mode.

2. The electronic apparatus according to claim 1, wherein when the standby mode is set to a power-saving mode, the CPU stops providing the clock signal to the DRAM, and controls the power IC to stop supplying the power to the DRAM.

3. The electronic apparatus according to claim 2, wherein a first wake-up time is required for returning to the user interface from the fast reboot mode, a second wake-up time is required for returning to the user interface from the power-saving mode, and the first wake-up time is shorter than the second wake-up time.

4. The electronic apparatus according to claim 2, wherein when the standby mode is set to the power-saving mode, power consumption of the electronic apparatus is smaller than 0.5 W.

5. The electronic apparatus according to claim 2, wherein the CPU provides a user interface for setting the standby mode.

6. The electronic apparatus according to claim 1, wherein the CPU comprises a system-on chip (SoC) and a system management (SM) unit; when the standby mode is set to the fast reboot mode, the SoC stops providing the clock signal to the DRAM, and the SM unit controls the power IC to continuously supply the power to the DRAM.

7. The electronic apparatus according to claim 6, wherein the power IC comprises a power supply circuit and a general purpose input/output (GPIO) pin; the SM unit controls the power supply unit via the GPIO pin to continuously supply the power to the DRAM.

8. The electronic apparatus according to claim 1, wherein when the standby mode is set to the fast reboot mode, current consumption of the DRAM is 15 mA to 30 mA.

9. The electronic apparatus according to claim 1, wherein the CPU further determines whether the standby mode is set to the fast reboot mode.

10. A power management method for an electronic apparatus, comprising:
when a standby mode of the electronic apparatus is set to a fast reboot mode, stopping providing a clock signal to a DRAM and continuously supplying the power to the DRAM; and
the DRAM entering self-refresh mode.

11. The power management method according to claim 10, further comprising:
when the standby mode is set to a power-saving mode, stopping providing the clock signal to the DRAM, and stopping supplying the power to the DRAM.

12. The power management method according to claim 11, wherein a first wake-up time is required for returning to the user interface from the fast reboot mode, a second wake-up time is required for returning to the user interface from the power-saving mode, and the first wake-up time is shorter than the second wake-up time.

13. The power management method according to claim 11, wherein when the standby mode is set to the power-saving mode, power consumption of the electronic apparatus is smaller than 0.5 W.

14. The power management method according to claim 10, wherein when the standby mode is set to the fast reboot mode, current consumption of the DRAM is 15 mA to 30 mA.

15. A power management method for an electronic apparatus, comprising:
providing a user interface for setting a standby mode;
when the standby mode is set to a fast reboot mode, stopping providing a clock signal to a DRAM and continuously supplying the power to the DRAM, so that the DRAM enters a self-refresh mode; and
when the standby mode is set to a power-saving mode, stopping providing the clock signal to the DRAM and stopping supplying the power to the DRAM.

16. The power management method according to claim 15, wherein a first wake-up time is required for returning to the user interface from the fast reboot mode, a second wake-up time is required for returning to the user interface from the power-saving mode, and the first wake-up time is shorter than the second wake-up time.

17. The power management method according to claim 15, wherein when the standby mode is set to the power-saving mode, power consumption of the electronic apparatus is smaller than 0.5 W.

18. The power management method according to claim 15, wherein when the standby mode is set to the fast reboot mode, current consumption of the DRAM is 15 mA to 30 mA.
